(19) United States
(12) Patent Application Publication
(10) Pub. No.: US 2006/0254444 A1
(43) Pub. Date: Nov. 16, 2006

(54) Method for producng a printing plate for intaglio printing and corrsponding printing plate

(75) Inventors: Roland Mayerhofer, Rottenbach (DE); Harald Deinhammer, Wien (AT)

Correspondence Address: HENRY M FEIEREISEN, LLC, 350 FIFTH AVENUE, SUITE 4714, NEW YORK, NY, 10118, US

(73) Assignee: OESTERREICHISCHE BANKNOTEN-UND SICHERHEITSDRUCK GM, WEIN (AT)

(21) Appl. No.: 10/563,080

(22) PCT Filed: Jun. 18, 2004
(86) PCT No.: PCT/AT04/00210

§ 371 Date: Jul. 18, 2006

(30) Foreign Application Priority Data
Jul. 3, 2003 (AT) A 1021/2003

(51) Int. Cl. B41C 3/08

(52) U.S. Cl. 101/401.1

(57) ABSTRACT

The invention relates to a method for producing a printing plate for intaglio printing. According to said method, a laser is used to create recesses and/or lines in a base body consisting of a brass alloy and/or having an outer layer consisting of a brass alloy.

The present invention relates to a method for producing a printing plate for intaglio printing.

When producing security documents, particularly bank notes, certificates, deeds, or the like, it is typical to perform at least one printing stage as intaglio printing, in which very high pressures are used. Therefore, printing plates for intaglio printing must withstand high loads.

In known methods for producing a printing plate for intaglio printing, a photopolymer plate is exposed, an operating matrix is electroformed from the exposed plate, and the printing plate is electroformed from the operating matrix. This method has the disadvantage that the production of a printing plate is very time-consuming. Furthermore, it is disadvantageous that errors often occur during the electroforming or the removal of the electroplated layer, which require tedious retouching of the operating matrix or the printing plate, the operating matrix or the printing plate possibly having to be discarded. A further disadvantage is that the depths of the lines, which are particularly a function of the exposure time and the line width, may not be selected independently of one another.

In other known methods, different line depths may be achieved by using multiple exposure templates in a multistage exposure process. In this case, the disadvantage is that no running line depths may be generated and these methods are particularly subject to error and are time-consuming.

The object of the present invention is to specify a method of the type cited at the beginning, in which the known disadvantages are avoided, and which requires little time and has high reliability and precision.

This is achieved according to the present invention in that depressions and/or lines are introduced into a base body made of a brass alloy and/or having an outer layer made of a brass alloy using a laser.

The advantage thus results that the printing plate has the required strength, the stability under load particularly also being able to be elevated by chroming. Furthermore, fine structures may be introduced into the base body using the laser. The precision of these structures may also be improved by a posttreatment for removing melt burrs. A further advantage is that the depths of the lines may be selected independently of one another, through which an increase of the security of the documents produced using the printing plate is made possible.

In a refinement of the present invention, melt burrs may be removed after the introduction of the depressions and/or lines. The precision of the lines and/or depressions may thus be significantly increased, through which the reproducibility of the printing plate and its resolution may be improved.

In this connection, according to a further embodiment of the present invention, the melt burrs may be removed using a chemical posttreatment, particularly an acid bath, an electrolytic bath, or the like. The melt burrs may be removed easily and rapidly using a chemical posttreatment, only the copper oxide or the zinc oxide of the melt burrs, and not the material of the base body, being removed in a targeted way.

According to a further embodiment of the present invention, the acid bath may comprise acetic acid, phosphoric acid, and nitric acid, particularly approximately 40 volume-percent acetic acid, 50 volume-percent phosphoric acid, and 10 volume-percent nitric acid. With this composition of the acid bath, a reflective and planar surface of the base body may be achieved even with an immersion treatment of a few minutes, further posttreatment steps not being required.

In a further refinement of the present invention, the depths for each of the depressions and/or lines and and/or for a group of depressions and/or lines may be predefined independently of one another. An additional safety feature may be implemented through a differing selection of the depths of the depressions and/or lines, through which the security from forgery of documents produced using the printing plate may be increased. Furthermore, it may be ensured in other embodiments of the printing plate according to the present invention that all depressions and/or lines have essentially the same depth, through which an especially uniform printed image may be ensured.

According to a further embodiment of the present invention, a flat plate may be used as the base body. A flat plate may be processed simply and rapidly, through which the production time required for the printing plate may be kept especially low.

In this connection, in a refinement of the present invention, an engraving head, which is connected to the laser, and/or the base body may be connected to a slide element movable in at least two different directions which are essentially parallel to the flat plate. The engraving head and/or the base plate may thus be moved easily in the direction of the lines and/or depressions to be generated. Furthermore, the movement may be optimized in such a way that the shortest possible production time of the printing plate is achieved and the proportion of areas which are passed over without being treated is as small as possible.

In a further embodiment of the present invention, the base body may be chromed in a further method step. The service life of the printing plate may be increased further by the chroming.

According to a further embodiment of the present invention, the emission of laser pulses may be monitored by a control device. Orderly implementation of the depressions and/or lines may be monitored easily by the control device, through which immediate posttreatment of laser pulses which are left out is made possible and the reliability of the method according to the present invention is improved.

Furthermore, the present invention relates to a printing plate for intaglio printing.

Known printing plates of this type are made of electroplated and chromed nickel. The disadvantage in this case is that the production of these printing plates is very time-consuming and tedious retouching and postprocessing steps, such as grinding, polishing, or the like, of the printing plates are necessary because of the production, the printing plate possibly also having to be discarded because of flaws.

The object of the present invention is to specify a printing plate of the above-mentioned type which avoids the known disadvantages and may be produced easily and rapidly.

This is achieved according to the present invention in that it comprises a base body made of a brass alloy and/or having an outer layer made of a brass alloy.

The advantage thus results that the printing plate has a high strength, the stability under load particularly also being able to be elevated by chroming. Furthermore, fine structures may be introduced into the base body using a laser, the precision of the structures being able to be improved even further by a posttreatment for removing melt burrs.

In a further embodiment of the present invention, the printing plate may have depressions and/or lines of different depths, the depth of the depressions and/or lines being independent of the width of the depressions and/or lines, through which the security of documents produced using the printing plate according to the present invention may be increased. An additional security feature may be implemented by a distribution of the depths of the depressions and/or lines which may be predefined.

According to another embodiment of the present invention, the Vickers hardness of the brass alloy may be greater than 140. A sufficient stability under load of the printing plate according to the present invention may thus be ensured.

The present invention will be described in greater detail with reference to the attached drawing, in which embodiments are illustrated.

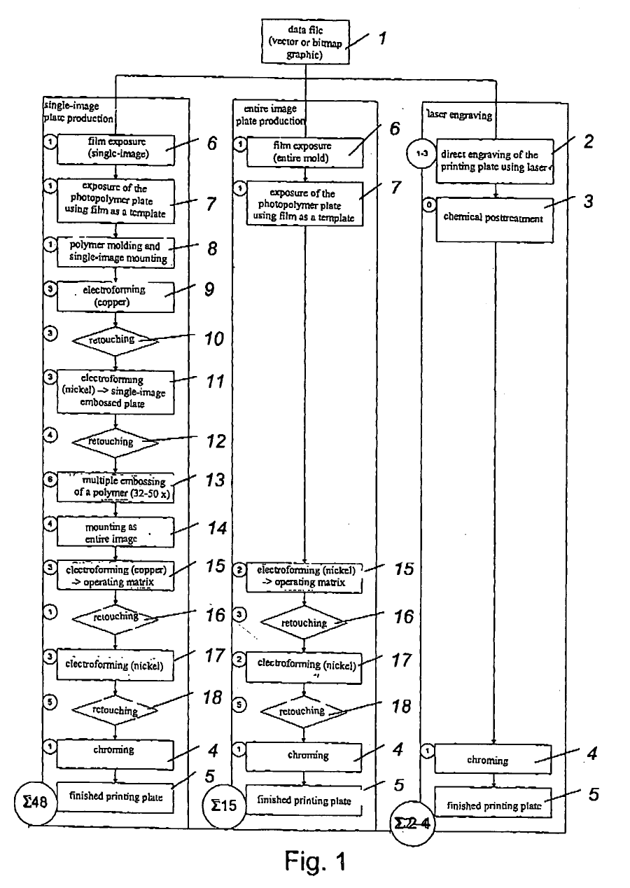

FIG. 1 shows method sequences of different manufacturing methods of printing plates for intaglio printing; and

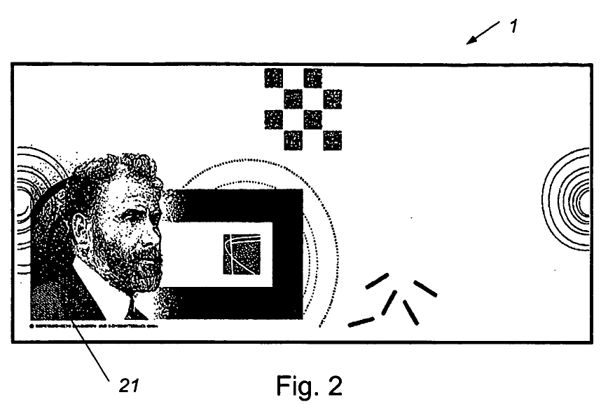

FIG. 2 shows the area on a banknote printed using intaglio printing.

The method sequences of two known methods and an embodiment of a method according to the present invention for producing a printing plate for intaglio printing are illustrated in FIG. 1. The numbers in the circles specify the time in days required for the particular step.

In this case, one starts from a graphic 1, which may particularly be provided in electronic form as a data file. In the method illustrated in the middle column, a film, which essentially has the size of a base plate to be produced, on which the graphic 1 is positioned multiple times, is first exposed in a method step 6. Subsequently, a photopolymer plate is exposed in a method step 7 using the film as a template, after which an operating matrix is generated from the a photopolymer plate in a further method step 15 using electroforming, the flaws of the operating matrix being retouched in a method step 16. In a method step 17, a printing plate is produced from the operating matrix using electroforming, which is retouched in a method step 18 and chromed in a method step 4, through which a finished printing plate 5 is obtained. This method requires a time of approximately 15 days.

In the known method illustrated in the left column, only one illustration of the graphic 1 is exposed on the film in the method step 6, which is used as a template for exposing the photopolymer plate in the method step 7. In order to obtain the operating matrix, in which the graphic 1 is contained multiple times, in the intermediate steps 8 through 15, firstly a single-image embossed plate is produced using polymer molding 8, electroforming 9, subsequent retouching 10, and renewed electroforming 11, using which multiple individual images are embossed, after renewed retouching 12, in a method step 13, which are assembled in method step 14 into an overall image, from which the operating matrix is electroformed in method step 15. The further method for producing the finished printing plate corresponds to the method described above. In this case, approximately 48 days are required for producing a finished printing plate.

Typically, multiple printing plates, particularly three, are mounted on a printing roller for intaglio printing. Approximately 9 further days are required for producing two further printing plates from the operating matrix.

According to the method according to the present invention for producing a printingplate for intaglio printing, an embodiment of which is illustrated in FIG. 1 in the right column, depressions and/or lines are introduced into a base body made of a brass alloy using a laser. In other embodiments of the method according to the present invention, a base body made of a composite material having an outer layer made of a brass alloy may also be provided.

Brass refers to copper-zinc alloys which have at least 50% copper. In addition to copper and zinc, brasses may also contain up to 3% lead. If still further elements besides lead are also alloyed, these are called special brasses. Brass alloys as defined in the present invention may be both brasses and also special brasses.

The information of a graphic file may be converted directly into control commands for the laser using a computer-controlled laser system. The production of the printing plate may thus be performed directly after preparing the graphic file, essentially no further intermediate steps being required.

In a preferred embodiment of the method according to the present invention, in addition to the contour of the depressions and/or lines, the depth of the depressions and/or lines is also predefined. This may be performed individually for each depression and/or line or jointly for a group of depressions and/or lines. In this case, the setpoints of the individual depths are independent from one another. Different depths may be achieved easily in the method according to the present invention through power regulation of the laser beam or through multiple laser applications.

In typical printing plates, during whose production method a photopolymer plate or the like is exposed, predefining different depths of the depressions and/or lines is not possible, since the depths are predefined by the exposure step. Because of the production, broad lines have a greater depth than thin lines in such printing plates.

In contrast, in the method according to the present invention, the depths of the depressions and/or lines may be predefined independently from their width. The depth of a single line may also change over its course, the width of this line being able to remain the same.

A solid base mode laser, preferably a diode-pumped Nd:YAG laser, may be used as the laser.

Because of its beam profile, the laser beam penetrates in a cone shape into the material surface. Melting processes arise in the boundary area of the focused beam which cause a part of the material to solidify in undesired ejections and sprays. The type and size of the boundary ejection are a function of the material, the pulse power, and the engraving depth. Metals, ceramics, and some plastics may be engraved using the laser, the power density of the laser beam being so high that the material partially vaporizes within a few nanoseconds during the processing. A depression which is colorless per se—the engraving—arises in the material. Oxides frequently form due to the interaction of the molten base material with the air oxygen, which cause the engraving to be more pronounced because of their color.

If a flat plate is used as the base body, the depressions and/or lines may be introduced especially rapidly and easily, through which the required production time may be kept low. In this case, an engraving head, which is connected to the laser, and/or the base plate may be attached to a slide element movable in at least two different directions which are essentially parallel to the flat plate, through which an engraving head movable in the xy directions and/or a base plate movable in the xy directions is implemented.

It is thus possible to move the laser beam from any point of the flat plate to another arbitrary predefined point of the flat plate along an arbitrary predefined curve, in particular even a straight line. For a predefined pattern, in particular the graphic file described above, a movement sequence may be established which ensures the lowest possible production time of the printing plate. It is not necessary in this case to completely cover areas in which lines and/or depressions are not to be introduced.

The engraving head may have a fixed optic or a galvanically deflected mirror system (galvanic system). Particularly good quality of the laser treatment and low production time may be achieved through a combination of these two optics. In other embodiments of the method according to the present invention, multiple galvanically deflected mirror systems may be provided, which are optimized for different line widths and depth ranges. Using the engraving head, vector-based graphics 1 may be processed in addition to punctual graphics 1 and therefore only those areas which contain a printed image may be processed in a targeted way.

A banknote 20 which has an area 21 having intaglio printing is shown in FIG. 2. It is typical in this case that the area 21 does not extend over the entire banknote 20.

In other embodiments of the method according to the present invention, the base body may also be curved, particularly in the form of a cylinder, cylindrical section, or the like.

In the method according to the present invention, the reliability and quality of the printing plate may be monitored easily during the introduction of the depressions and/or lines using a control device by detecting the emission of laser pulses. If a laser pulse is not emitted, the control device may issue the command for repeated emission of a laser pulse, through which the danger of the occurrence of flaws is reduced.

The precision of the depressions and/or lines may be improved if the melt burrs which arise during the introduction of the depressions and/or lines in the base body are removed. These melt burrs essentially comprise oxidized material of the base body, particularly copper oxide or zinc oxide.

A chemical posttreatment appears especially suitable for removing the melt burrs, which may particularly comprise an acid bath, an electrolytic bath, or the like. It may be ensured in this case that the copper oxide or the zinc oxide is removed by the chemical posttreatment, but not the brass alloys of the base body.

The chemical posttreatment may particularly be performed through immersion of the base body in an acid bath or the like which comprises phosphoric acid, acetic acid, nitric acid, arsenic acid, or the like or a combination of these acids. An acid bath which comprises acetic acid, phosphoric acid, and nitric acid appears especially favorable, the acid bath particularly being able to have approximately 40 volume-percent acetic acid, 50 volume-percent phosphoric acid, and 10 volume-percent nitric acid.

After the introduction of the depressions and/or lines and possibly after the removal of the melt burrs, retouching and/or checking of the printing plate may also be provided in order to be able to recognize possibly existing flaws and correct them.

The service life of the printing plate may be improved further if the base body is chromed in a further method step.

Using the method according to the present invention, a printing plate for intaglio printing is produced which comprises a base body made of a brass alloy and/or a composite material having an outer layer made of a brass alloy. In this case, it has been shown that a brass alloy has a suitable strength for a printing plate for intaglio printing and sufficiently fine structures may be introduced into the base body using a laser.

Furthermore, the melt burrs formed by the laser may be removed easily and rapidly through a posttreatment with a base body made of a brass alloy.

In order to ensure a suitable strength of the printing plate, it appears favorable if the brass alloy has a Vickers hardness greater than 140.

The printing plate according to the present invention may have depressions and/or lines of different depths, the depths of the depressions and/or lines being able to be predefined independently of the width of the depressions and/or lines. The different depths of the depressions and/or lines may form a separate security feature or be a component of another security feature. In this case, lines having a running depth may be provided in particular.

In the selection of the material for the printing plates, its mechanical properties are of great importance, since the color transfer occurs primarily through the very high contact pressure of the printing plate on the printed material (paper or polymer) in intaglio printing. Pressures of up to 60 tons are used industrially for this purpose. In order to achieve a high service life, materials having a low hardness, such as copper, are not suitable for printing plates for intaglio printing.

Furthermore, it is of great importance that the material used may be processed in optimum fineness by the laser and the ejected material may be removed as easily as possible and above all selectively. On the basis of expensive studies, nickel or steel also appear less suitable for use in the method according to the present invention. With these materials, the subsequent chemical treatment always also results in removal, though it is slight, of the base material, which has a negative influence on the line fineness.

It has been shown that hardened brass variants fulfill all requirements to be used for intaglio printing in security printing.

1. A method for producing a printing plate for intaglio printing, comprising the steps of introducing depressions and/or lines into a base body made of a brass alloy and/or having an outer layer made of a brass alloy using a laser, wherein the brass alloy has a Vickers hardness which is greater than 140.

2. The method according to claim 1, further comprising the step of removing melt burrs after the introduction of the depressions and/or lines.

3. The method according to claim 2, wherein the melt burrs are removed using a chemical posttreatment.

4. The method according to claim 13, wherein the acid bath comprises acetic acid, phosphoric acid, and nitric acid.

5. The method according to claim 1 wherein the depressions and/or lines and/or a group of depressions and/or lines have depths which are predefined independently of one another.

6. The method according to claim 1, wherein a flat plate is used as the base body.

7. The method according to claim 6, wherein the laser is attached to a slide element which is movable in at least two different directions that are essentially parallel to the flat plate.

8. The method according to claim 1, further comprising the step of chroming the base body.

9. The method according to claim 1, further comprising the step of monitoring emission of laser pulses by a control device.

10. A printing plate for intaglio printing, comprising a base body made of a brass alloy and/or having an outer layer made of a brass alloy.

11. The printing plate according to claim 10, wherein the base body has depressions and/or lines of different depths, the depths of the depressions and/or lines being independent of a width of the depressions and/or lines.

12. The printing plate according to claim 10, wherein the brass alloy has a Vickers hardness which is greater than 140.

13. The method according to claim 3, wherein the melt burrs are removed using an acid bath.

14. The method according to claim 3, wherein the melt burrs are removed using an electrolytic bath.

15. The method according to claim 13, wherein the acid bath comprises approximately 40 volume-percent acetic acid, 50 volume-percent phosphoric acid, and 10 volume-percent nitric acid.
